(19) United States
(12) Patent Application Publication
(10) Pub. No.: US 2013/0272767 A1
(43) Pub. Date: Oct. 17, 2013

(54) PRINTER AND ROLL HOLDER

(71) Applicant: Takuya Tanaka, Shizuoka (JP)

(72) Inventor: Takuya Tanaka, Shizuoka (JP)

(73) Assignee: TOSHIBA TEC KABUSHIKI KAISHA, Tokyo (JP)

(21) Appl. No.: 13/446,123

(22) Filed: Apr. 13, 2012

(51) Int. Cl. B41J 13/00; B65H 16/04

(52) U.S. Cl. 400/578; 242/597

(57) ABSTRACT

A roll holder includes a shaft portion configured to hold a roll member formed by winding a strip-shaped material. A pair of wall portions is configured to restrain axial movement of the roll member held by the shaft portion. Also, a reduction unit is provided in the roll holder to reduce frictional resistance against a force by which the strip-shaped material is drawn from the roll member whose axial movement is restrained by the wall portions.

### FIELD

Embodiments described herein relate generally to a printer and a roll holder.

### BACKGROUND

A printer including a roll holder may include a shaft portion for rotatably holding a roll member formed by winding a strip-shaped material and a pair of wall portions for restraining a movement of the roll member along its axial direction, a conveying unit for drawing the strip-shaped material out of the roll member rotatably held by the roll holder with respect to a main body of the printer and conveying the strip-shaped material, and a printing unit for performing printing on the strip-shaped material conveyed by the conveying unit.

In this type of printer, when drawing the strip-shaped material from the roll member, the wall portions for restraining the axial movement of the roll member may have frictional resistance against the strip-shaped material being drawn away from the roll member.

### BRIEF DESCRIPTION OF THE DRAWINGS

FIG. 1 is a perspective view showing the schematic configuration of a printer according to a first embodiment, in which a cover for opening and closing the internal space of a main body of the printer is removed for clarity.

FIG. 2 is a side view of the printer.

FIG. 3 is an exploded perspective view of a roll holder.

FIG. 4 is a perspective view of first reduction members in an assembled state.

FIG. 5 is an exploded perspective view of the first reduction members.

FIG. 6 is a schematic diagram of a roll member having warps made when second reduction members are absent.

FIG. 7 is an exploded perspective view of a roll holder according to a second embodiment.

FIG. 8 is an exploded perspective view of a roll holder according to a third embodiment.

### DETAILED DESCRIPTION

According to one embodiment, a roll holder includes a shaft portion configured to hold a roll member formed by winding a strip-shaped material, a pair of wall portions configured to restrain an axial movement of the roll member held by the shaft portion, and a reduction unit configured to reduce frictional resistance against a force by which the strip-shaped material is drawn out of the roll member.

Certain embodiments will now be described with reference to the accompanying drawings.

In the following description, the same components included in different embodiments will be designated by like reference symbols and will not be described repeatedly.

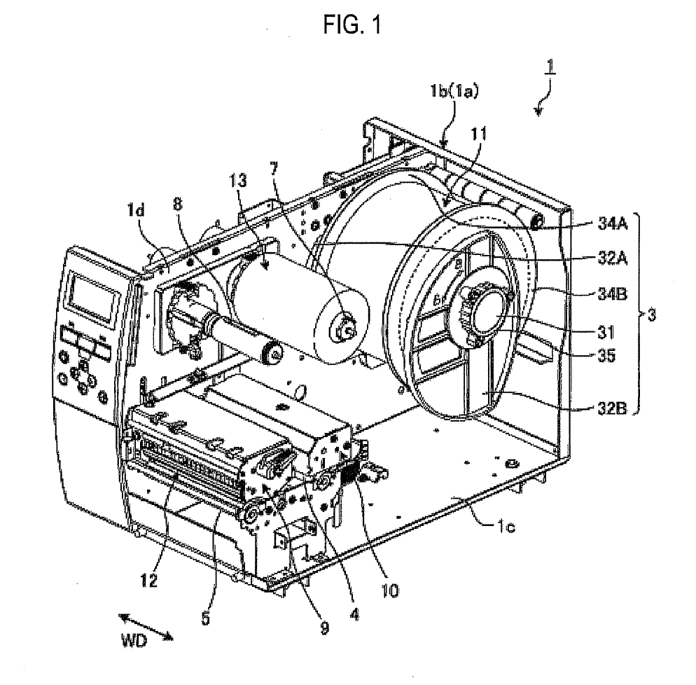

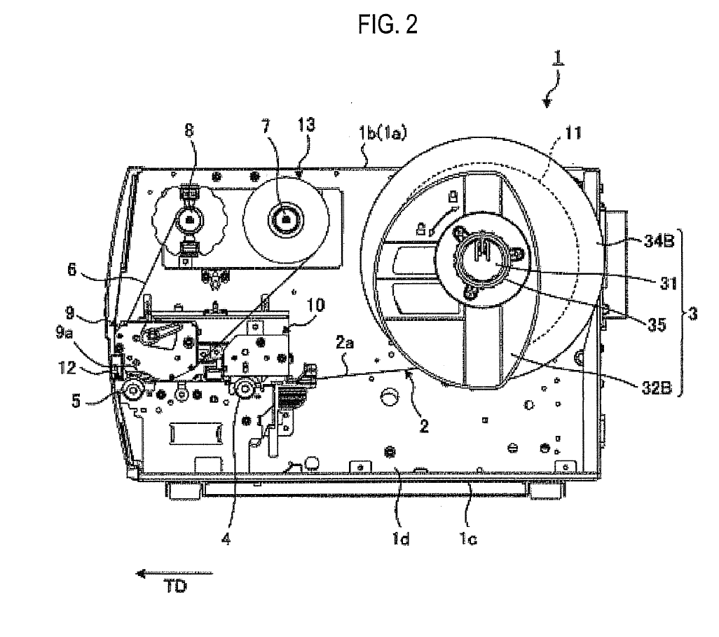

FIG. 1 is a perspective view showing a schematic configuration of a printer 1 according to a first embodiment, in which a cover (not shown) for opening and closing the internal space of a body unit 1a of the printer 1 is removed for clarity. FIG. 2 is a side view of the printer 1 as seen from the right side in the width direction WD of the printer 1 in FIG. 1.

As shown in FIGS. 1 and 2, the body unit 1a of the printer 1 includes a housing (body housing) 1b. The housing 1b includes a bottom wall 1c, a cover (not shown) and a vertical wall 1d disposed perpendicular to the bottom wall 1c and parallel to a side wall (not shown) in the width direction WD of the cover.

In the printer 1 of the present embodiment, a roll holder 3, a conveying roller 4, a platen roller 5, a supply shaft 7 for an ink ribbon 6, a take-up shaft 8 for the ink ribbon 6, a printing block 9 and a pinch roller block 10 are attached to the vertical wall 1d in a position substantially perpendicular to the vertical wall 1d.

At the left side in the width direction WD of the vertical wall 1d as seen in FIG. 1 (at the rear side of the vertical wall 1d as seen in FIG. 2), motors (not shown) configured to rotationally drive the conveying roller 4 and the platen roller 5 and a control circuit (not shown) configured to control a thermal head 9a of the printing block 9 or other units are accommodated within the housing 1b.

The roll holder 3 serves to hold a roll member 11 such as a paper roll formed by winding a strip-shaped material 2, e.g., a strip-shaped paper, so that the roll member 11 can rotate about an axis perpendicular to the view plane of FIG. 2. A plurality of labels (not shown) as print media is attached (bonded with adhesive) to an inner surface 2a of the strip-shaped material 2 (see FIG. 2).

The roll holder 3 of the present embodiment includes a shaft portion 31 configured to hold the roll member 11, a pair of wall portions (which may be referred to as “paper end guides” or “guide fences”) 32A and 32B configured to restrain an axial movement of the roll member 11 held by the shaft portion 31. Also, the roll holder 3 includes a reduction unit (having first reduction members 33A and 33B and second reduction members 34A and 34B) configured to reduce frictional resistance against a force by which the strip-shaped material 2 is drawn out of the roll member 11 whose axial movement is restrained by the wall portions 32A and 32B.

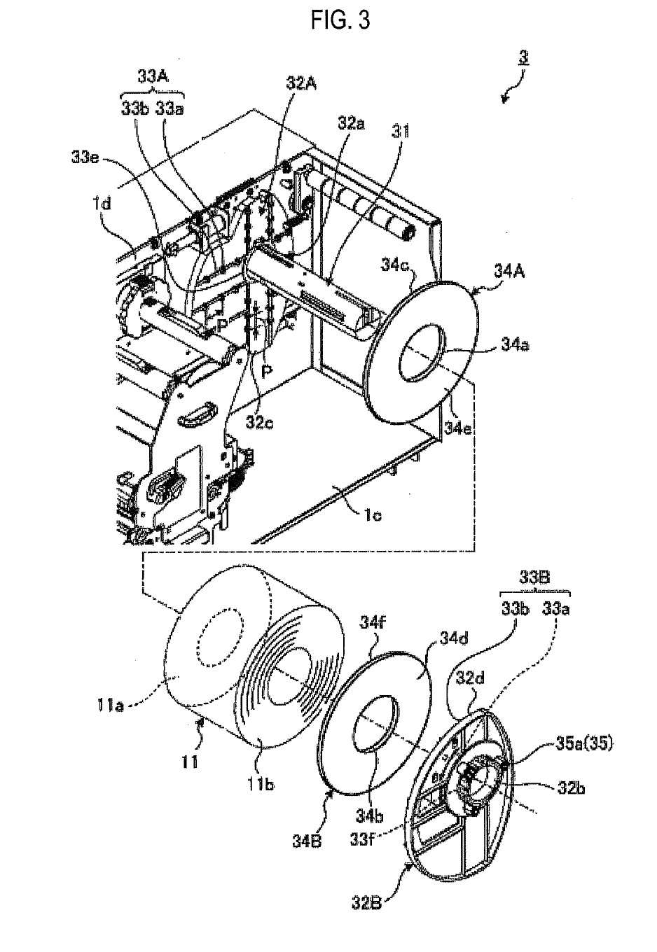

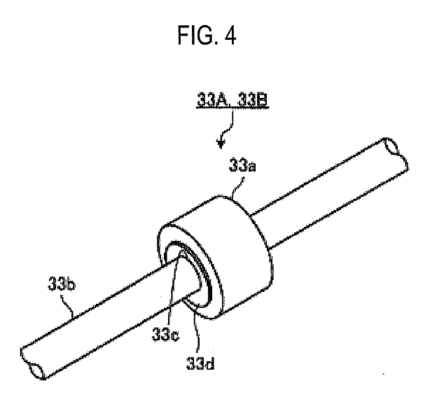

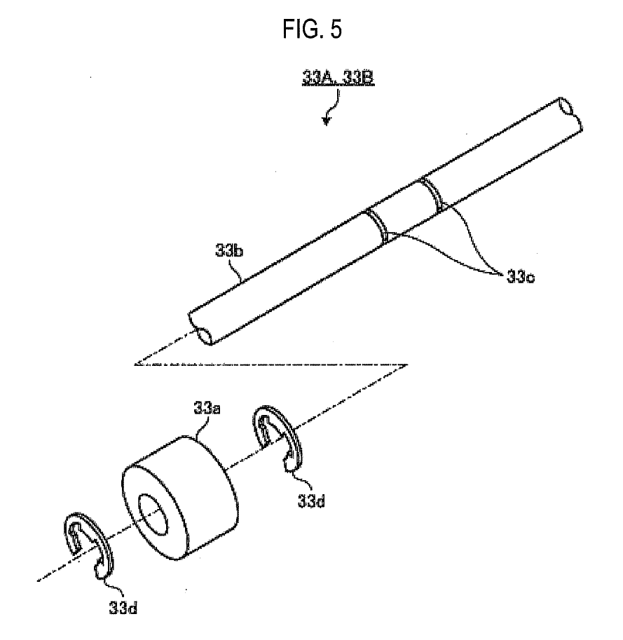

FIGS. 3 to 5 are views for explaining a more detailed configuration of the roll holder 3 according to the first embodiment. FIG. 3 is a perspective view of the roll holder 3 in an exploded state. FIG. 4 is a perspective view of first reduction members 33A and 33B in an assembled state. FIG. 5 is an exploded perspective view of the first reduction members 33A and 33B shown in FIG. 4.

As depicted in FIG. 3, the roll holder 3 of the present embodiment includes the shaft portion 31 fixed to the vertical wall 1d.

The roll holder 3 of the present embodiment further includes a fixed wall 32A attached to the vertical wall 1d, the fixed wall 32A having a shaft-attaching hole 32a through which one end of the shaft portion 31 is attached to the vertical wall 1d. Further, a movable wall 32B is detachably coupled to the shaft portion 31 attached to the vertical wall 1d through the fixed wall 32A, the movable wall 32B having an insertion hole 32b into which the other end of the shaft portion 31 is inserted.

The roll holder 3 further includes first reduction members 33A and 33B respectively provided on the opposing surfaces 32c and 32d of the fixed wall 32A and the movable wall 32B. The fixed wall 32A and the movable wall 32B are arranged opposite the axial side surfaces 11a and 11b of the roll member 11 held by the shaft portion 31.

The roll holder 3 further includes second reduction members 34A and 34B of disc-like shape rotatably held by the shaft portion 31, the second reduction members 34A and 34B having insertion holes 34a and 34b for receiving the shaft portion 31 inserted therethrough. The second reduction members 34A and 34B respectively includes planar surfaces 34c and 34d opposite the opposing surfaces 32c and 32d of the first reduction members 33A and 33B and planar surfaces 34e and 34f making contact with the side surfaces 11a and 11b of the roll member 11 held by the shaft portion 31. The second reduction members 34A and 34B makes slide contact with the opposing surfaces 32c and 32d of the first reduction members 33A and 33B, respectively. The second reduction members 34A and 34B are configured to reduce frictional resistance in cooperation with the first reduction members 33A and 33B.

The roll holder 3 further includes a fixing portion 35 for fixing the movable wall 32B to the shaft portion 31. More specifically, the fixing portion 35 includes knobs 35a. If the knobs 35a are rotated about the shaft portion 31 by a user, the movable wall 32B is fixed with respect to the shaft portion 31.

The respective components 31 through 35 of the roll holder 3 may be formed using hard materials, e.g., molded with a resin or other applicable materials.

As shown in FIGS. 3 to 5, the first reduction members 33A and 33B include a plurality of cylindrical rolling members 33a arranged on the opposing surfaces 32c and 32d.

Specifically, the rolling members 33a are arranged at a specified pitch P along a plurality of shaft members 33b provided on the opposing surfaces 32c and 32d, and configured to rotate around the shaft members 33b. As illustrated in FIGS. 4 and 5, each of the rolling members 33a is supported on each of the shaft members 33b. A movement of each rolling member 33a along the axial direction of each of the shaft members 33b is restrained by a pair of retaining members 33d, e.g., E-shaped stopper rings (E-rings), engaging with a pair of grooves 33c formed on each of the shaft members 33b.

In the present embodiment, one side ends of the shaft members 33b are fixed to ring-shaped protrusions 33e and 33f, which are formed on the opposing surface 32c of the fixed wall 32A and the opposing surface 32d of the movable wall 32B, respectively, to allow insertion of the shaft portion 31 therethrough. Also, the other side ends of the shaft members 33b are fixed to edge portions of the opposing surfaces 32c and 32d. With this configuration, the shaft members 33b are arranged to be spaced apart by a specified distance from the opposing surfaces 32c and 32d so that the rolling members 33a are rotatable along the shaft members 33b. Alternatively or additionally, a plurality of grooves through which the rolling members 33a can rotate may be formed on the opposing surfaces 32c and 32d, so that the shaft members 33b are supported at such positions as to make contact with the opposing surfaces 32c and 32d.

The following is a description on how to use the roll holder 3 according to the first embodiment.

In order to load the roll member 11 into the body unit 1a of the printer 1 through the use of the roll holder 3, a user first brings the disc-shaped second reduction member 34A, the roll member 11 to be used, the disc-shaped second reduction member 34B and the movable wall 32B into engagement with the shaft portion 31 attached to the shaft-attaching hole 32a of the fixed wall 32A in the named order. Then, the user pushes the disc-shaped second reduction member 34A, the roll member 11 to be used, the disc-shaped second reduction member 34B and the movable wall 32B against the fixed wall 32A with pressure, thereby appropriately restraining the axial movement of the roll member 11. Finally, the user rotates, in this movement-restrained state, the knobs 35a of the fixing portion 35 in a fixing direction so that the movable wall 32B can be fixed with respect to the shaft portion 31.

On the other hand, when the roll member 11 needs to be unloaded from the roll holder 3, the user performs the afore-mentioned procedures in the reverse order. More specifically, the user first rotates the knobs 35a of the fixing portion 35 in a releasing direction, thereby releasing the fixing of the movable wall 32B to the shaft portion 31. Then, the user removes the movable wall 32B, the second reduction member 34B, the roll member 11 to be unloaded and the second reduction member 34A in the named order.

A rack-and-pinion mechanism (not shown) capable of centering and positioning the wall portions, i.e., the fixed wall 32A and the movable wall 32B, is formed in the shaft portion 31 shown in FIG. 3. Use of the rack-and-pinion mechanism makes it possible to align the roll member 11 in the center position between the fixed wall 32A and the movable wall 32B.

As shown in FIG. 2, the printer 1 of the present embodiment is configured such that the strip-shaped material 2 drawn out of the roll member 11 is held between the conveying roller 4 and the pinch roller block 10 (pinch roller not shown). If the conveying roller 4 is rotationally driven by a motor (not shown), the strip-shaped material 2 is drawn and conveyed from the roll member 11.

In the printer 1, a ribbon roll member 13 formed by winding an ink ribbon 6 is held by the supply shaft 7 for the ink ribbon 6. If the take-up shaft 8 is rotationally driven by a motor (not shown), the ink ribbon 6 is wound around the take-up shaft 8 and drawn from the ribbon roll member 13.

Further, in the printer 1, the ink ribbon 6 and the strip-shaped material 2 are held between the thermal head 9a of the printing block 9 and the platen roller 5. The thermal head 9a is heated to melt the ink of the ink ribbon 6 and prints information (images) such as letters and barcodes on the labels attached to the inner surface 2a of the strip-shaped material 2.

In the printer 1 of the present embodiment, the conveying roller 4, the platen roller 5, the motors (not shown) configured to rotationally drive the rollers 4 and 5, the motor controller (not shown) configured to control the rotation of the motors and the pinch roller block 10 constitute a conveying unit for drawing the strip-shaped material 2 from the roll member 11 rotatably held on the body unit 1a by means of the roll holder 3 and conveying the strip-shaped material 2 thus drawn.

In the printer 1 of the present embodiment, the ink ribbon 6, the supply shaft 7, the take-up shaft 8, the printing block 9 (the thermal head 9a), the motors (not shown) configured to rotationally drive the supply shaft 7 and the take-up shaft 8, the motor controller (not shown) configured to control the rotation of the motors constitute a printing unit 12 for performing printing on the strip-shaped material 2 conveyed by the conveying unit.

The labels (not shown) subjected to printing in the printing unit 12 are peeled from the strip-shaped material 2 by a contact member (not shown), which is arranged at the downstream side of the printing unit 12 in the conveying direction TD and extends along the width direction WD (see FIG. 1) of the strip-shaped material 2. Then, the labels are discharged outside of the body unit 1a.

According to the present embodiment described above, the reduction unit (the first reduction members 33A and 33B and the second reduction members 34A and 34B) of the roll holder 3 enables the wall portions (the fixed wall 32A and the movable wall 32B) to properly restrain axial movement of the roll member 11 and makes it possible to reduce frictional resistance against the drawing force (the conveying force of the strip-shaped material 2) by which the strip-shaped material 2 is drawn from the roll member 11. This makes it possible to perform the conveying of the strip-shaped material 2 and the printing at a desired speed, thereby preventing deterioration of printing quality.

More specifically, different types of roll members having different axial lengths can be selectively used in the printer set forth above. In a conventional printer, however, the task of adjusting the width between a pair of wall portions is manually performed by a user. Therefore, if too much pressing force (hereinafter just referred to as “pressing force”) is applied from the wall portions to a roll member, the frictional resistance of the axial side surfaces of the roll member against the contact surfaces of the wall portions becomes higher, consequently increasing the resistance against the force by which a strip-shaped material is drawn from the roll member. This poses a problem in that the conveying speed of the strip-shaped material and the printing speed are decreased and the printing quality is reduced. On the other hand, if the pressing force is too small, gaps are formed between the axial side surfaces of the roll member and the contact surfaces of the wall portions. Thus, the roll member is axially moved during the operation of drawing the strip-shaped material. This leads to a problem of deteriorating the print quality.

In the conventional printer, when loading the roll member to the printer, a user needs to properly adjust the pressing force depending on the type of the roll member so that the problems mentioned above should not occur. This is troublesome to the user and deteriorates the usability of the printer.

According to the printer 1 of the first embodiment, even if a great amount of pressing force is applied to the roll member 11 by the wall portions, i.e., the fixed wall 32A and the movable arms 7, the rotation of the rolling members 33a of the first reduction members 33A and 33B can reduce the frictional resistance against the drawing force (the conveying force of the strip-shaped material 2), thereby maintaining a proper conveying speed of the strip-shaped material 2 and a proper printing speed. This makes it possible to prevent deterioration of the printing quality.

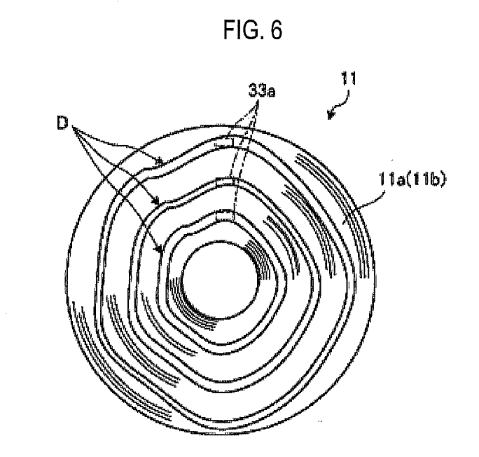

According to the printer 1 of the first embodiment, the second reduction members 34A and 34B made of a hard material is operated to prevent the first reduction members 33A and 33B from being inserted into the gaps between the layers of the strip-shaped material 2 on the side surfaces 11a and 11b of the roll member 11. Accordingly, it is possible to prevent damage D such as warps which would otherwise occur on the side surfaces 11a and 11b of the roll member 11 as shown in FIG. 6. As compared with a case where the first reduction members 33A and 33B are composed of rib members (see the second embodiment to be described later), it is also possible to accurately reduce the frictional resistance against the drawing force (the conveying force of the strip-shaped material 2).

According to the printer 1 of the first embodiment, when loading the roll member 11, the user only needs to set the roll member 11 between the fixed wall 32A and the movable wall 32B so as not to form any gap between the opposing surfaces 32c and 32d of the second reduction members 34A and 34B and the side surfaces 11a and 11b of the roll member 11, without having to pay attention to the pressing force applied to the roll member 11 by the wall portions, i.e., the fixed wall 32A and the movable wall 32B, and then fix the movable wall 32B to the shaft portion 31 using the fixing portion 35. This makes it possible to enhance the ease of use.

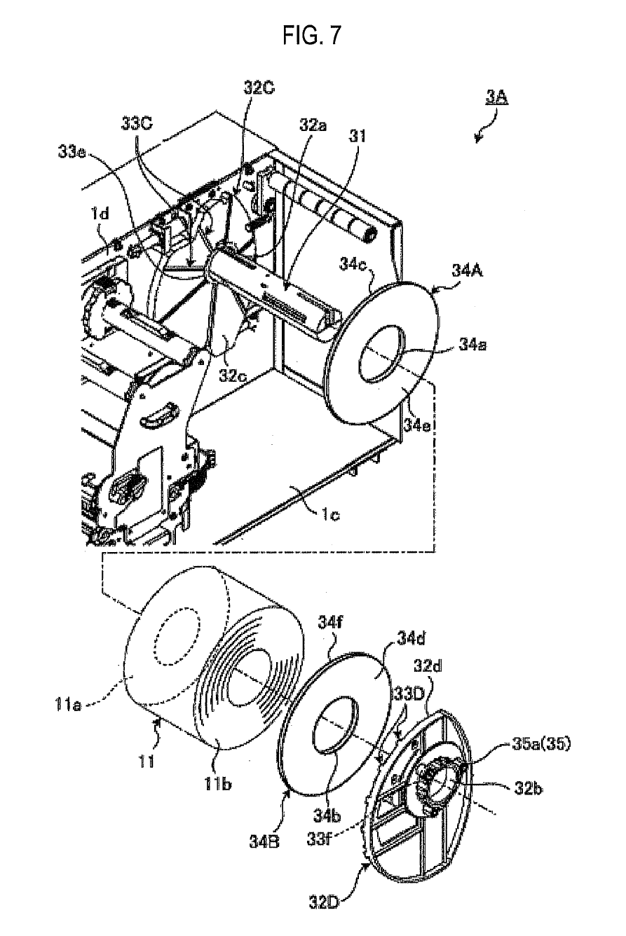

Next, a second embodiment will be described with reference to FIG. 7.

FIG. 7 is an exploded perspective view of a roll holder 3A according to the second embodiment, which is a modification of the roll holder 3 of the first embodiment described above.

The roll holder 3A of the second embodiment differs from the roll holder 3 of the first embodiment in that the first reduction members 33A and 33B including the rolling members 33a, the shaft members 33b, the grooves 33c and the retaining members 33 are replaced by first reduction members 33C and 33D including a plurality of rib members formed on the opposing surfaces 32c and 32d. More specifically, the rib members constituting the first reduction members 33C and 33D are formed on the opposing surfaces 32c and 32d to extend radially outwards from ring-shaped protrusions 33e and 33f (shaft-attaching holes 32a) for attachment of the shaft portion 31, which are formed on the opposing surfaces 32c and 32d of the fixed wall 32C and the movable wall 32D.

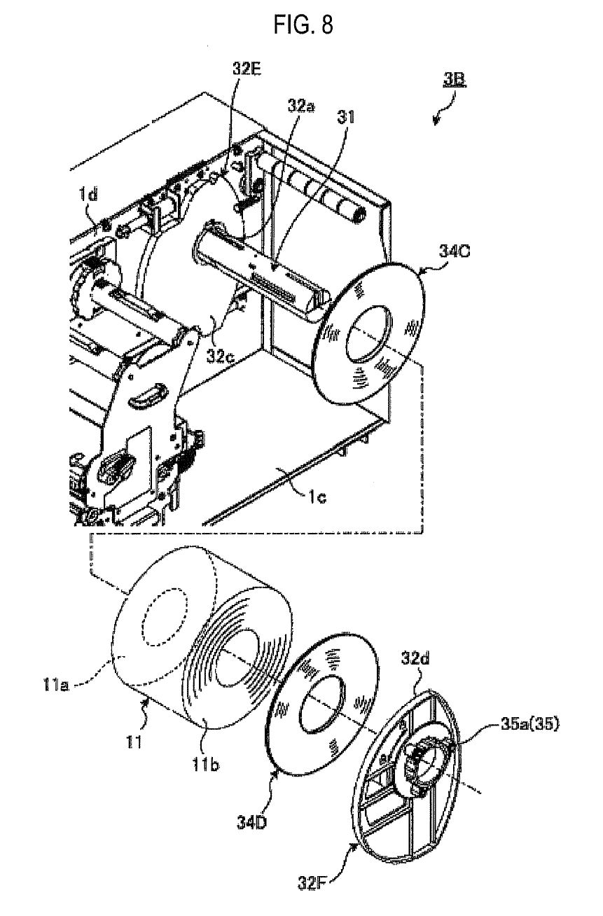

Next, a third embodiment will be described with reference to FIG. 8.

FIG. 8 is an exploded perspective view of a roll holder 3B according to the third embodiment, which is a modification of the roll holder 3 and the roll holder 3A of the first and second embodiments described above.

The roll holder 3B of the third embodiment differs from the roll holder 3 of the first embodiment and the roll holder 3A of the second embodiment in that the wall portions, i.e., the fixed wall 32A and the movable wall 32B, of the roll holder 3 and the roll holder 3A are modified to have planar opposing surfaces 32c and 32d on which the first reduction members 33A to 33D are not formed. Another difference from the first and second embodiments is that the disc-shaped second reduction members 34A and 34B of the roll holder 3 and the roll holder 3A molded with a hard material such as a resin are modified to disc-shaped second reduction members 34C and 34D formed of a Teflon™ sheet having low frictional resistance.

According to the second and third embodiments, similar to the first embodiment, the wall portions (the fixed wall 32A and the movable wall 32B) can properly restrain axial movement of the roll member 11 and can reduce frictional resistance against the drawing force (the conveying force of the strip-shaped material 2) by which the strip-shaped material 2 is drawn from the roll member 11. This makes it possible to perform the conveying of the strip-shaped material 2 and the printing at a desired speed, thereby preventing deterioration of the printing quality and enhancing the ease of use.

While description has been made on certain illustrative embodiments, the present disclosure shall not be limited thereto.

For example, while the first embodiment (or the second embodiment) has been described with reference to a case where the roll holder 3 (or the roll holder 3A) is provided with the first reduction members 33A and 33B (or the first reduction members 33C and 33D) formed on both the fixed wall 32A and the movable wall 32B (or both the fixed wall 32C and the movable wall 32D), the present disclosure is not limited thereto. Alternatively, the roll holder 3 (or the roll holder 3A) may be provided with a first reduction member formed on only one of the fixed wall 32A and the movable wall 32B (or only one of the fixed wall 32C and the movable wall 32D).

While the first embodiment (or the second embodiment) has been described with reference to a case where the roll holder 3 (or the roll holder 3A) is provided with two second reduction members 34A and 34B, the present disclosure is not limited thereto. Alternatively, the roll holder 3 (or the roll holder 3A) may be provided with only one second reduction member 34A (or second reduction member 34B) or three or more second reduction members.

In the first embodiment (or the second embodiment), the second reduction members 34A and 34B may be omitted.

While the first embodiment (or the second embodiment) has been described with reference to a case where the surfaces of the second reduction members 34A and 34B making contact with the fixed wall 32A and the movable wall 32B, respectively, and the surfaces of the second reduction members 34A and 34B making contact with the side surfaces 11a and 11b of the roll member 11 held by the shaft portion 31, respectively, are plane surfaces. Alternatively, members configured to reduce frictional resistance (e.g., ribs) may be provided on the surfaces making contact with the side surfaces 11a and 11b of the roll member 11.

While the first embodiment has been described to be configured such that a plurality of rolling members 33a is arranged on each of the shaft members 33b, the present disclosure is not limited thereto. Alternatively, a single rolling member 33a may be arranged on each of the shaft members 33b.

While the first embodiment has been described to be configured such that a plurality of rolling members 33a having a small width in the axial direction of each of the shaft members 33b is arranged on each of the shaft members 33b, the present disclosure is not limited thereto. Alternatively, only a single rolling member 33a of long cylindrical shape having an axial width greater than the width of the rolling members 33a of the first embodiment may be arranged on each of the shaft members 33b.

While the first, second and third embodiments have been described to be configured such that the shaft portion 31 of the roll holder 3, 3A or 3B is fixed to the body unit 1a of the printer 1 (i.e., the vertical wall 1d of the housing 1b) and the roll member 11 is rotatably held by the shaft portion 31 fixed to the body unit 1a, the present disclosure is not limited thereto. Alternatively, the shaft portion 31 of the roll holder 3, 3A or 3B may be rotatably attached to the body unit 1a and the roll member 11 may be held to rotate together with the shaft portion 31 with respect to the body unit 1a.

While the first, second and third embodiments have been described to have a configuration where the fixed wall 32A, 32C or 32E is arranged independently of the vertical wall 1d of the body unit 1a, the present disclosure is not limited thereto. Alternatively, the fixed wall 32A, 32C or 32E may be integrally formed with the body unit 1a of the printer 1 (e.g., the vertical wall 1d).

While the first, second and third embodiments have been described to have a configuration where the fixed wall 32A, 32C or 32E is fixed to the vertical wall 1d, the present disclosure is not limited thereto. Alternatively, the fixed wall 32A, 32C or 32E may be arranged to be movable.

While the embodiments described above are directed to the printer that can perform printing on labels (not shown) as printed media adhesively bonded to one surface (the inner surface 2a) of the strip-shaped material (backing sheet) 2 (see FIG. 2), the present disclosure is not limited thereto. Alternatively, the embodiments described above may be applied to, e.g., a printer capable of performing printing on a continuous paper (liner-less label) as a print medium without a strip-shaped material (backing sheet) or a printer capable of reading and writing data from/to an RFID chip attached to a label.

While the embodiments described above are directed to the printer 1 provided with the roll holder 3, 3A or 3B, the roll holder 3, 3A or 3B may be provided separately from the printer.

In the embodiments described above, the external configuration, hardware configuration and software configuration of the printer and the configuration and shape of the respective components of the roll holder 3, 3A or 3B are presented merely by way of example. The embodiments of the present disclosure are not limited thereto.

While certain embodiments have been described, these embodiments have been presented by way of example only, and are not intended to limit the scope of the inventions. Indeed, the novel printer and roll holder described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A roll holder, comprising:
a shaft portion configured to hold a roll member;
a pair of wall portions configured to restrain axial movement of the roll member held by the shaft portion; and
a reduction unit configured to reduce frictional resistance between a strip-shaped material drawn from the roll member and the pair of wall portions.

2. The roll holder of claim 1, wherein each of the pair of wall portions has an opposing surface opposite one axial side surface of the roll member held by the shaft portion, the reduction unit including a first reduction member provided on the opposing surface and a second reduction member rotatably held by the shaft portion and provided with a planar surface making slidable contact with the first reduction member, the second reduction member configured to reduce frictional resistance in cooperation with the first reduction member.

3. The roll holder of claim 1, wherein each of the wall portions has an opposing surface opposite one axial side surface of the roll member held by the shaft portion, the reduction unit including a plurality of rolling members arranged on the opposing surface.

4. The roll holder of claim 1, wherein each of the wall portions has an opposing surface opposite one axial side surface of the roll member held by the shaft portion, the reduction unit including a plurality of rib members formed on the opposing surface to extend radially outwards from a shaft-attaching hole for attachment of the shaft portion defined on the opposing surface.

5. The roll holder of claim 1, wherein each of the wall portions has an opposing surface opposite one axial side surface of the roll member held by the shaft portion, the reduction unit including a Teflon sheet having reduced frictional resistance, the Teflon sheet rotatably held by the shaft portion and provided with a planar surface making contact with the opposing surface.

6. A printer, comprising:
a shaft portion configured to hold a roll member;
a pair of wall portions configured to restrain axial movement of the roll member held by the shaft portion;
a reduction unit configured to reduce frictional resistance against a force by which a strip-shaped material is drawn from the roll member;
a conveying unit configured to draw the strip-shaped material from the roll member held by the shaft portion and convey the strip-shaped material; and
a printing unit configured to perform printing on the strip-shaped material conveyed by the conveying unit.

7. The printer of claim 6, wherein each of the wall portions has an opposing surface opposite one axial side surface of the roll member held by the shaft portion, the reduction unit including a first reduction member provided on the opposing surface and a second reduction member rotatably held by the shaft portion and provided with a planar surface making slidable contact with the first reduction member, the second reduction member configured to reduce the frictional resistance in cooperation with the first reduction member.

8. The printer of claim 6, wherein each of the wall portions has an opposing surface opposite one axial side surface of the roll member held by the shaft portion, the reduction unit including a plurality of rolling members arranged on the opposing surface.

9. The printer of claim 6, wherein each of the wall portions has an opposing surface opposite one axial side surface of the roll member held by the shaft portion, the reduction unit including a plurality of rib members formed on the opposing surface to extend radially outwards from a shaft-attaching hole for attachment of the shaft portion defined on the opposing surface.

10. The printer of claim 6, wherein each of the wall portions has an opposing surface opposite one axial side surface of the roll member held by the shaft portion, the reduction unit including a Teflon sheet having reduced frictional resistance, the Teflon sheet rotatably held by the shaft portion and provided with a planar surface making contact with the opposing surface.
